(19) United States
(12) Patent Application Publication
(10) Pub. No.: US 2024/0423306 A1
(43) Pub. Date: Dec. 26, 2024

(54) ANTIMICROBIAL FACE MASK

(71) Applicant: Nexvera LLC, Kensington, CA (US)

(72) Inventors: John H. Larsen, North Vancouver (CA); Hugh Douglas, Kensington, CA (US); Richard Kent Berger, Framingham, MA (US)

(21) Appl. No.: 18/813,762

(22) Filed: Aug. 23, 2024

Related U.S. Application Data
(63) Continuation of application No. PCT/US2023/013596, filed on Feb. 22, 2023.
(60) Provisional application No. 63/313,097, filed on Feb. 23, 2022.

(51) Int. Cl. A41D 13/11

(52) U.S. Cl. CPC A41D 13/1192

(57) ABSTRACT

An antimicrobial face mask that includes a triboelectric nanogenerator (TENG) membrane interior portion. The face mask also includes one or more antimicrobial substances. In some examples, the face mask includes both copper and silver, each of which has antimicrobial properties and together have a greater antimicrobial effect than each of them individually. The face mask improves upon existing personal protective equipment (PPE) face masks to reduce transmission and infection from microbial pathogens, including SARS-CoV-2, its variants, other viruses and various forms of bacteria.

### CROSS-REFERENCE TO RELATED APPLICATION

This application claims priority to PCT Application No. PCT/US2023/013596 which claims priority to Provisional Application 63/313,097 filed on Feb. 23, 2022, the entire disclosures of which are incorporated by reference herein and for all purposes.

### BACKGROUND

This disclosure relates to face masks used by healthcare workers and the public at large for the purpose of inactivating airborne (bioaerosol) infectious viruses and killing bacteria that cause disease.

Face masks have been used in hospitals and laboratories for decades in order to protect the user from various agents such as blood spray, dangerous chemical vapors and airborne infectious viruses and other infectious agents.

The N95 mask has been widely deployed more recently through the COVID-19 pandemic as a means to reduce inhalation of bioaerosol droplets containing virions of SARS-CoV-2 and emerging variants.

Part of the N95 mask declared specification states 95% reduction of particles greater than 0.3 microns. While the surgical-grade N95 mask can provide the highest protection level, its filtration efficiency against particles with sizes of 0.3 microns is under test conditions. This efficiency is shown to get lower for smaller particles sizes.

The SARS-CoV-2 virion is measured at 0.05 to 0.12 microns and therefore may penetrate through the filter fabric of the N95 mask. The potential leak-through of virions over periods of continuous use (e.g., a worker's use through an entire shift) may indeed lead to infection from excessive viral load buildup.

In addition, the necessary filtration factor of N95 masks disrupts airflow to the user and furthermore creates a breeding ground for bacteria.

Accordingly, there is a need to improve upon existing PPE face masks which are somewhat effective at filtering out airborne (bioaerosol) viral and bacterial pathogens.

### SUMMARY

Aspects and examples are directed to a face mask that has an interior antimicrobial layer and an exterior antimicrobial layer. There is a triboelectric nanogenerator (TENG) membrane located between the interior and exterior antimicrobial layers. The TENG membrane comprises two different flexible layers having distinct triboelectric polarities. The face mask is able to reduce the viral infection rate, bacterial buildup and fomite transmission, while still providing adequate airflow to the user.

According to the present invention, there is provided an antimicrobial face mask that includes a multiple fabric layer portion which reduces the transmission and infection of airborne pathogens.

Microbial pathogens include viruses and bacteria. Non-limiting examples of viruses that may be inactivated by the face mask include influenza, enteroviruses, and coronaviruses (e.g., SARS-CoV-2, Influenza A, Influenza B, H1N1, enterovirus, and Feline calicivirus).

Non-limiting examples of bacteria that may be killed by the face mask include Listeria monocytogenes, Pseudomonas maltophilia, Thiobacillus novellus, Staphylococcus aureus, Streptococcus pyrogens, Streptococcus, Escherichia coli O157, Salmonella enterica, Campylobacter jejuni, Clostridium difficile, Listeria monocytogenes and Mycobacterium tuberculosis.

The antimicrobial face mask includes a single or multiple fabric layer TENG interior portion to improve upon existing PPE face masks by reducing transmission and infection caused by microorganisms, including SARS-CoV-2, its variants, other infectious viruses and various forms of bacteria.

One advantage of the present invention is improved breathability of the face mask which is achieved by the selection of porous materials that form the entire body of the face mask. The combination of these porous materials allows the air to flow through the front of the face mask freely with minimal restriction, thereby reducing air leakage around the perimeter of the mask.

A second advantage of the face mask is its ability to reduce infection through electrochemical means as compared to conventional filtering masks that restrict airflow to the user and therefore, cause air leakage around the perimeter of the mask.

All examples and features mentioned below can be combined in any technically possible way.

In one aspect, a face mask includes an interior antimicrobial layer and an exterior antimicrobial layer and a triboelectric nanogenerator (TENG) membrane located between the interior and exterior antimicrobial layers, wherein the TENG membrane comprises two different flexible layers having distinct triboelectric polarities.

Some examples include one of the above and/or below features, or any combination thereof. In an example, at least one layer of the TENG membrane comprises a porous mesh fabric. In an example, the exterior antimicrobial layer comprises copper. In an example, the exterior antimicrobial layer comprises a sputtered copper polyester fabric. In an example, the interior antimicrobial layer comprises silver. In an example, the interior antimicrobial layer comprises a silver-infused cotton fabric.

Some examples include one of the above and/or below features, or any combination thereof. In an example, the TENG membrane comprises a nylon fabric and a fabric selected from the group consisting of polyester, polytetrafluoroethylene, polydimethylsiloxane, polyvinyl chloride, polyimide, polypropylene, polyethylene and polyvinylidene fluoride.

Some examples include one of the above and/or below features, or any combination thereof. In an example, the TENG membrane comprises nylon and polyester fabrics. In some examples, the TENG membrane comprises two different porous mesh fabrics that have distinct triboelectric polarities. In an example, the two different porous mesh fabrics of the TENG membrane are adjacent to one another. In an example, the two different porous mesh fabrics of the TENG membrane are adjacent to one another and close enough such that they are configured to touch when the wearer breathes.

Some examples include one of the above and/or below features, or any combination thereof. In an example, the face mask further includes a breathable non-woven layer made from synthetic material and located between the interior layer and the TENG membrane. In an example, the breathable non-woven layer is made from a thermoplastic polymer.

Some examples include one of the above and/or below features, or any combination thereof. In an example, the face mask further includes at least one of two ear loops and a behind-the-head extension loop. In an example, the face mask further includes an embedded wire stiffener to secure the face mask at the nose when worn.

In another aspect, a face mask includes an interior antimicrobial layer of silver-infused cotton fabric, an exterior antimicrobial layer of sputtered copper polyester fabric, and a triboelectric nanogenerator (TENG) membrane located between the interior and exterior antimicrobial layers, wherein the TENG membrane comprises separate nylon-based and polyester-based porous mesh fabrics.

Some examples include one of the above and/or below features, or any combination thereof. In an example, the face mask further includes at least one of two ear loops and a behind-the-head extension loop, and an embedded wire stiffener to secure the face mask at the nose when worn. In an example, the two separate porous mesh fabrics of the TENG membrane are adjacent to one another. In an example, the two separate porous mesh fabrics of the TENG membrane are adjacent to one another and close enough such that they are configured to touch when the wearer breathes. In an example, the face mask further includes a breathable non-woven layer made from synthetic material and located between the interior layer and the TENG membrane.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 illustrates a perspective view of a four-layer embodiment of the face mask.

FIG. 2 illustrates a side perspective view of an embodiment of the face mask secured to a user's face.

FIG. 3 illustrates a side perspective view of another embodiment of the face mask secured to a user's face.

FIGS. 4A and 4B are rear and front perspective views, respectively, of the face mask.

FIG. 5 is a schematic cross-sectional view of a five-layer embodiment of the face mask.

### DESCRIPTION

Examples of the devices, systems, methods, and apparatuses discussed herein are not limited in application to the details of construction and the arrangement of components set forth in the following description or illustrated in the accompanying drawings. The devices, systems, methods, and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the computer program products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

In examples of the face mask, there is an interior antimicrobial layer and an exterior antimicrobial layer, and a triboelectric nanogenerator (TENG) membrane located between the interior and exterior antimicrobial layers. The TENG membrane comprises two different flexible layers having distinct triboelectric polarities. In some examples there is also a breathable non-woven layer made from synthetic material and located between the interior layer and the TENG membrane. In an example, the breathable non-woven layer is made from a thermoplastic polymer.

In an example, at least one layer of the TENG membrane comprises a porous mesh fabric. In an example, the exterior antimicrobial layer comprises copper. In an example, the exterior antimicrobial layer comprises a sputtered copper polyester fabric. In an example, the interior antimicrobial layer comprises silver. In an example, the interior antimicrobial layer comprises a silver-infused cotton fabric.

In an example, the TENG membrane comprises a nylon fabric and a fabric selected from the group consisting of polyester, polytetrafluoroethylene, polydimethylsiloxane, polyvinyl chloride, polyimide, polypropylene, polyethylene and polyvinylidene fluoride.

In an example, the TENG membrane comprises nylon and polyester fabrics. In some examples, the TENG membrane comprises two different porous mesh fabrics that have distinct triboelectric polarities. In an example, the two different porous mesh fabrics of the TENG membrane are adjacent to one another. In an example, the two different porous mesh fabrics of the TENG membrane are adjacent to one another and close enough such that they are configured to touch when the wearer breathes.

In an example, the face mask further includes at least one of two ear loops and a behind-the-head extension loop. In an example, the face mask further includes an embedded wire stiffener to secure the face mask at the nose when worn.

In another aspect, a face mask includes an interior antimicrobial layer of silver-infused cotton fabric, an exterior antimicrobial layer of sputtered copper polyester fabric, and a triboelectric nanogenerator (TENG) membrane located between the interior and exterior antimicrobial layers, wherein the TENG membrane comprises separate nylon-based and polyester-based porous mesh fabrics.

Following are further descriptions of concepts described in more detail below. These concepts support the scope of the invention but are not themselves limiting thereof.

Antimicrobials: Antimicrobial products kill or slow the spread of microorganisms. Microorganisms include bacteria, viruses, protozoans and fungi (e.g., mold and mildew).

Fomites: Inanimate objects or surfaces contaminated with infectious agents, referred to as fomites, play an important role in the spread or transmission of viruses and bacteria, including SARS-CoV-2, the virus responsible for the COVID-19 pandemic.

Receptor Binding Domain (RBD): The RBD in SARS-CoV-2 spike protein binds strongly to human and bat angiotensin-converting enzyme 2 (ACE2) receptors, in addition to TMPRSS2 receptors.

Triboelectric effect: When two or more different materials repeatedly collide with, or rub against, one another, the surface of one material can steal electrons from the other, thereby accumulating a charge.

Triboelectric Nanogenerator (TENG): A TENG is an energy harvesting device that is capable of converting external mechanical energy into electricity by the coupling effect of triboelectrification and electrostatic induction. The TENG membrane, which exploits the phenomenon behind static electricity, may consist of one or more textile layers as long as movement that agitates the material contained within the one or more layers, generates electrostatic charge.

Triboelectric Series: The triboelectric series is a list of materials showing those which have a greater tendency to become positive (+) and which have a greater tendency to become negative (−). When a material that is near the base of the series comes in contact with a material near the top of the series list, it will obtain more negative charge. Therefore, the farther away the two materials are from each other on the list, the greater the charge transmitted. The triboelectric series is a useful list in determining which combinations of materials create the most static electricity. Table 1 provides a triboelectric series of different materials based on the abilities of materials to gain/lose electrons (adopted from John Wiley & Sons. @ 2014 WILEY-VCH Verlag GmbH & Co. KgaA, Weinheim).

While the making and using of various embodiments of the present invention are discussed in detail below, it should be appreciated that the specific embodiments discussed herein are merely illustrative of the way to make and use the invention and do not delimit the scope of the invention. Those of ordinary skill in the art will recognize numerous equivalents to the specific devices, apparatus, and methods described herein. Such equivalents are considered to be within the scope of this invention and are covered by the claims.

This present invention provides a face mask and method to reduce the viral infection rate, bacterial buildup and fomite transmission, while still providing adequate airflow to the user. Fomite transmission is reduced through the copper layer when the mask is placed on an infected object or surface, and through physical human handling of the mask. A reduction in bacterial buildup is achieved through the use of a silver layer thereby lessening the potential for infection, such as sinusitis.

The face mask of the present invention may take various forms. There are several different types of commercially available face masks (existing PPE) designed to protect the user from potential contaminants in the immediate environment. N95 respirators and surgical masks are examples of PPE that are used to protect the user from particles or from liquid contaminating the face. A N95 respirator is a respiratory protective device designed to achieve a very close facial fit and very efficient filtration of airborne particles. On the other hand, a surgical mask is a loose-fitting, disposable device that creates a physical barrier between the mouth and nose of the user. Furthermore, the edges of the mask are not designed to form a seal around the nose and mouth whereas the edges of the respirator are designed to form a seal around the nose and mouth.

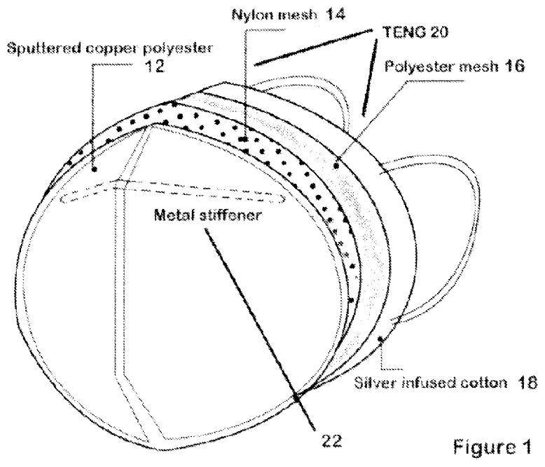

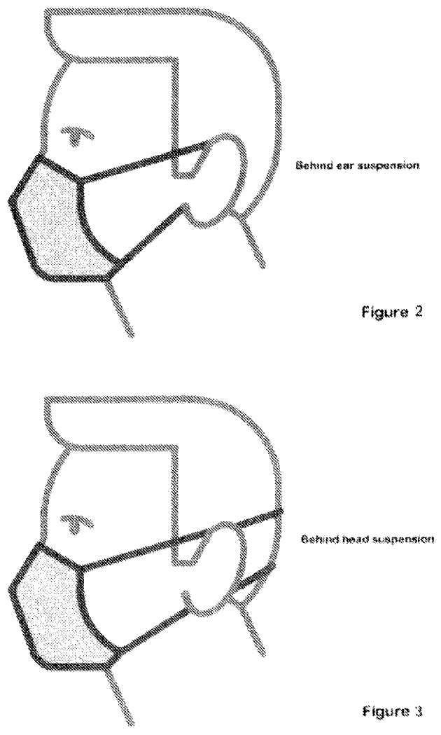

The face mask of the present invention is intended to have a close fit to the face as illustrated in FIGS. 2 and 3. The design may be in the form of a fold-flat or duck bill mask that includes a bendable metal reinforcement nose bar 22, as shown in FIG. 1, which allows a custom fit of the mask around the nose of a user. Either design is suitable for use with the present invention as are various other mask embodiments.

Exemplary mask 10 is shown in further detail in FIG. 1. Mask 10 includes four separate layers (12, 14, 16 and 18), arranged such that air flows through all four layers. Together, layers 14 and 16 function as a triboelectric nanogenerator (TENG) 20. TENG 20 is sandwiched between an exterior sputtered copper polyester layer 12 and interior silver infused cotton layer 18. Preferably, the mask 10 includes a bendable metal reinforcement nose bar 22 to allow custom fitting of the mask to the nose and face of the user. The use of the combined layers as shown in FIG. 1 is illustrative and may depend upon the specific application and its performance specifications.

After the SARS-CoV-2 virus was first reported in Wuhan, China in 2019, it was soon declared as a pandemic in 2020 due to the rapid spread of this infectious disease across the world. Although the principal mode of transmission of SARS-CoV-2 is via airborne exposure to respiratory droplets or direct contact in a person-to-person encounter, transmission via fomites from surfaces exposed to viral shedding from both asymptomatic and symptomatic patients is recognized as a contributing factor in the rapid spread of the virus. Since the virus can survive on various surfaces from hours to days, contamination of a clean surface can easily contribute to the spread of infection through simple human contact.

Copper (Cu) and its alloys (e.g., brass and bronze) are well-known to have excellent antimicrobial properties and for this reason, have been employed in numerous applications and materials to combat the spread of infectious diseases in public spaces and healthcare facilities, including their use on touch surfaces. Since the beginning of the pandemic, several research studies have shown that copper and its alloys can effectively inactivate the SARS-CoV-2 virus and therefore, continue to play a significant role in reducing the spread of viral infection. In light of these recent findings, copper surfaces can contribute significantly to the control of infection by limiting the spread of SARS-CoV-2 and other known pathogens caused by surface contamination.

The mechanism of copper's antimicrobial activity has been determined through extensive research and is beyond the scope of the teachings of this application. In general, the process is multifaceted with the main mechanism of bactericidal activity being attributed to the generation of reactive oxygen species (ROS) by the reduction of copper, both dependent and independent from Fenton chemistry, which are highly reactive and detrimental to cellular molecules. Depending on the microorganism, cell death is believed to be mediated by enzyme and non-enzyme mediated oxidative damage involving lipid peroxidation, protein oxidation and DNA damage. Furthermore, the release of copper ions, Cu+ and Cu2+, damage the membrane irreversibly, infiltrate the cell and induce an oxidative stress response involving endogenous ROS. Other studies have shown that the mechanism underlying copper's antiviral property is attributed to the release of ions from copper surfaces which causes RNA degradation and membrane disruption of enveloped viruses (e.g., SARS-CoV-2). In the case of fungi, the uptake of copper ions and physical deterioration of the membrane leading to copper ion influx are considered to be the primary mechanisms. (I. Salah, et al., “Copper as an antimicrobial agent: recent advances,” RSC Adv., 2021, 11, 18179)

Airborne respiratory pathogens can settle on the outer surface of a face mask through droplet, airborne or fomite transmission and therefore during handling of the mask, can pose a risk of infection to the mucous membranes of the face resulting in self-contamination. Thus, according to a first aspect of the present invention, the face mask comprises an exterior sputtered copper layer 12 as a first line of defense to reduce viral transmission and confer protection from additional pathogens through copper's inherent antimicrobial properties. Depending on the application, there are numerous commercially-available textiles comprising different blends of fibers that have copper incorporated therein.

According to one embodiment, the exterior layer 12 comprises a polyester mesh fabric that has sufficient porosity to permit unrestricted breathing air flow movement to the user when worn. Copper is incorporated into the fabric through a sputtering process in which a copper film is applied to both sides of the fabric and within the pores of the polyester mesh. It should also be noted the entire surface area on both sides of the fabric of the external layer, and within the pores of the polyester mesh, is coated with copper to provide optimal protection against infection caused by droplet, airborne or fomite transmission.

Based on recent scientific studies pertaining to the coronavirus, it has been shown that externally applied moderate electrostatic fields can have a deleterious effect on the RBD affinity of the SARS-CoV-2 spike proteins to the ACE2 receptor present on the host cell surface. Hence, the stability of the RBD depends largely on the electrostatic and hydrophobic interactions between associated proteins. As such, the TENG membrane 20 is incorporated into the face mask of the present invention for the purpose of applying an external Electrostatic Field (EF) to the SARS-CoV-2 S1 spike proteins and envelope (also called the capsid) through breathing airflow movement.

Thus, according to another aspect of the present invention, the TENG membrane 20 used in the face mask provides a triboelectric electrostatic charge effect through breathing airflow movement friction of two or more different fabric layers 14 and 16 having distinct triboelectric polarities that are situated adjacent to one another. When worn, an electron transfer occurs between the material surfaces of the different fabric layers through periodic contact/separation or lateral sliding movements caused by inhalation/exhalation or other facial movements of the user. The process of electron transfer between the material surfaces to compensate for the difference in surface potentials is called triboelectric charging. Since it is the electron, ion, or charged material transfer between the different materials which achieves the triboelectric charging, the specific materials used in the fabric layers will vary depending on their electrostatic potential.

The ability of a surface to be triboelectrically charged with respect to a reference surface is based on a triboelectric series which contains a list of common textile polymers and other materials that are ranked according to their ability to easily lose electrons (positive) to gain electrons (negative). For example, many synthetic polymers have the nature of being negatively charged while nylon, cotton, and aluminum are positively charged. Accordingly, it is the relative position of the two materials on the triboelectric series that defines which material gains electrons and which material loses electrons. A person of skill in the art would be familiar with numerous existing materials in the triboelectric series which facilitate their use in specific TENG applications because of their charge-carrying capacity.

Table 1 exemplifies a list of known materials that are ranked according to these properties. As is evident from the list, the materials used in triboelectric fabric layers are diverse and include polymers, metals, and inorganic materials. Textile materials composed of dielectric polymers such as cotton, nylon, polyester, polyethylene terephthalate (PET), polylactic acid, polyurethane (PU), polyimide (PI) and carbon fibers have been used as wearable TENG contact surfaces. The most commonly used materials are dielectric polymers such as polytetrafluoroethylene (PTFE), fluorinated ethylene propylene (FEP), PDMS, and Kapton. In some cases, additional triboelectric coatings using materials such as PTFE, polydimethylsiloxane (PDMS), silicone rubber, perylene, and polyvinylidene fluoride (PVDF), which are also associated with textiles, have been used to enhance triboelectric performance.

TABLE 1

| | | |
|---|---|---|
| POSITIVE (+) 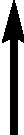 | Polyformaldehyde 1.3-1.4 Ethylcellulose Polyamide 11 (Nylon 11) Polyamide (Nylon 6-6) Melamine formal Wool, knitted Silk, woven Aluminum | 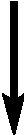 |
| | Paper | |
| | Cotton, woven | |
| | Steel | |
| | Wood | |
| | Hard rubber | |
| | Nickel, Copper | |
| | Sulfur | |
| | Brass, Silver | |
| | Acetate, Rayon | |
| | Polymethyl methacrylate (Lucite) | |
| | Polyvinyl alcohol | |
| | Polyester (Dacron) | |
| | Polyisobutylene | |
| | Polyurethane flexible sponge | |
| | Polyethylene terephthalate (PET) | |
| | Polyvinyl butyral | |
| | Polychlorobutadiene | |
| | Natural rubber | |
| | Polyacrilonitrile | |
| | Acrylonitrile-vinyl chloride | |
| | Polybisphenol carbonate | |
| | Polychloroether | |
| | Polystyrene | |
| | Polyvinylidine fluoride (PVDF) | |
| | Polyethylene (PE) | |
| | Polypropylene (PP) | |
| | Polyimide (Kapton) | |
| | Polyvinyl chloride (PVC) | |
| | Polydimethylsiloxane (PDMS) | |
| | Polytetrafluoroethylene (Teflon) | |

Selecting materials for the friction layers according to the triboelectric series is generally straightforward in that the further away two materials are from each other in the series, the greater the charge transferred when they're in friction contact with each other and higher the amount of charge that is generated. Hence, an optimal material selection for the TENG membrane or triboelectric filter would be in choosing materials that are further apart in the triboelectric series which will produce a higher triboelectric charge separation and greater charge transfer. The materials with a higher surface charge density that can generate a higher TENG output are also desirable. Scientific studies have shown that depending on the fabrics employed, triboelectric nanogenerators have been able to generate electrostatic fields measuring from 2 to 35 kV when the fabric layers contact each other in contact-separation, freestanding rotary and freestanding sliding motions (Yuan Bai et al., “Theory and applications of high-voltage triboelectric nanogenerators”, Cell Reports Physical Science, Volume 3, Issue 11, 16 Nov. 2022).

Triboelectric charging can also be enhanced by physically modifying the surface of the material with microstructures or nanopatterns that increase the contact surface area and/or introducing chemical functional groups to increase the material's surface potential. Thus, commonly used techniques for optimizing the electrical performance of a TENG membrane are selecting types of material that are further apart in the triboelectric series, providing sufficient contact between triboelectric surfaces through physical or chemical modification to increase surface roughness, and/or enhancing the electrical properties through chemical modification.

Since the TENG membrane 20 of the present invention is employed in a wearable device, another important consideration in selecting suitable materials is the comfort of the material when worn next to the face. In this regard, the selected materials should also be biocompatible, flexible and breathable while maintaining an optimal triboelectrically charged output performance.

In one embodiment of the present invention, the TENG membrane 20 is formed from separate nylon and polytetrafluoroethylene (PTFE) mesh fabric layers. Since nylon and PTFE are at opposite ends of the triboelectric series, they can generate a high electric field through contact electrification. Furthermore, since PTFE is a typical electret, it can maintain a negative charge on its surface for an extended period of time. Other preferred combinations of suitable porous mesh materials for the TENG membrane 20 are nylon and polypropylene, polyimide or polyester.

Other possible preferred combinations of materials which may be suitable for use in the TENG membrane 20 include Nylon/Polydimethylsiloxane (PDMS); Nylon/Polyvinyl chloride (PVC); Nylon/Polyethylene (PE); or Nylon/Polyvinylidine fluoride (PVDF).

The porosity of both mesh layers should be high enough so that when worn, breathing through the mask is not substantially impeded. Generally, commercially available synthetic mesh fabrics are available in a range of pore sizes from, for example, about 0.05 mm to 2.0 mm. Preferably, the pore size of the mesh layers range from about 0.1 to about 1.0 mm. It is desirable that the mesh layers comprise evenly space openings that create a breathable effect along the entire surface area of the material when utilized in the TENG membrane.

The fabric layer order may also vary as other materials become available that may enhance the desired characteristics of this present invention.

There are more than ninety S1 spikes which protrude from the envelope capsid of the SARS-CoV-2 virus, and other coronaviruses. An electrostatic charge present in mask 10 is effective to reduce the RBD affinity of coronaviruses by altering the electrostatic symmetry and/or charge of the S1 spike protein. Therefore, by disrupting the biomechanics of the virus binding spikes to ACE2 receptors, and other receptors such as TMPRSS2 found on the surface mammalian host cells, mask breathability and effectiveness is maintained without filtration mechanisms found in conventional masks, that would otherwise disrupt airflow.

SARS-CoV-2 spike proteins are formed by three protomers of non-covalently bonded protein subunits. The binding of the RBD with the epithelium receptor destabilizes the spikes leading to conformational changes in the spike from a tetrahedron-like shape (prefusion) to nail-like (postfusion) morphology. Recent evidence showed that this morphological transition of the spike protein could also occur before it anchors to the host cell receptors (Nicolas Moreno et al., “Hydrodynamics of spike proteins dictate a transport-affinity competition for SARS-CoV-2 and other enveloped viruses,” Sci Rep 12, 11080, 2022).

Under the action of an EF, the electric dipole moments of a protein can be reoriented along the field direction in order to minimize the electrostatic energy. On the other hand, a rearrangement of the dipoles can cost conformational energy due to the loss of hydrogen bonds. As a result of the balance between conformational and electrostatic energies, along with entropic contributions, the protein can undergo a significant conformational change when subjected to an EF.

Molecular Dynamics simulations have shown that EFs of moderate intensities cause damage to the spike protein that adversely affects its docking interaction with ACE2, making SARS-CoV-2 potentially less infectious. The field intensities spanned a range between 104 Vm⁻¹ and 10⁷ Vm⁻¹ in order to cover both low and moderate intensities that are not incompatible with living organisms and can even exist inside cells (Claudia R. Arbeitman et al., “The SARS-CoV-2 spike protein is vulnerable to moderate electric fields,” Nature Comm., 2022 Jun. 29; 13:3752; Weizhu Yan et al., “Structural biology of SARS-CoV-2: open the door for novel therapies,” Sig Transduct Target Ther 7, 26, 2022).

In this context, the triboelectric charge generated by the TENG membrane 20 of the face mask through the breathing airflow movements has the potential to modify the surface charge distribution of the spike protein which would adversely affect the RBD binding affinity to the ACE2 receptor. Consequently, interference of the docking interaction between the RBD and the ACE2 receptor by modifying their electrostatic complementarity makes SARS-CoV-2 virus less infectious. Hence, when worn by healthcare workers and the public at large, the face mask can help reduce viral transmission through inactivation of the SARS-CoV-2 virus by the triboelectric-generated electrostatic charge effect of the TENG membrane.

Silver (Ag) is also well-known for its antimicrobial properties against bacteria, viruses and fungi and like copper, is being extensively researched with renewed interest in light of the recent pandemic.

Based on its excellent antimicrobial properties, silver has been employed in numerous medical applications and materials to combat the spread of infectious diseases through surface contamination (e.g., catheters, wound dressings, fabrics). The effectiveness of silver to target and destroy microorganisms is attributed to the biologically active positively charged silver ions (Ag+).

Silver ions are known to have several modes of action in destroying bacteria that include: (i) blocking the transportation of molecules in and out of the cell by binding to bacterial cell membrane proteins; (ii) irreversibly damaging key enzyme systems in the cell membrane; (iii) destroying energy production by blocking the respiratory system when transported into the bacterial cell; and (iv) inhibiting bacterial cell division by interacting with bacterial DNA to stop their replication. Furthermore, the antibacterial action of silver has long been known to be enhanced by the presence of an electric field.

Although the exact mechanism by which silver exerts its antiviral properties is still under investigation, it has been observed that the metal ions interact with the structural proteins on the surface of extracellular viruses. This interaction occurs at an early stage to inhibit infection by either preventing viral attachment to the surface of a host cell or by damaging the surface proteins which adversely affect the structural integrity and binding ability of the virus. In a recent study, silver has been shown to be effective against both enveloped (e.g., coronaviruses) and non-enveloped viruses. Silver inactivates enveloped viruses through a charge-based interaction with their outer lipid envelope layer and non-enveloped viruses through formation of bonds with sulfur groups on key proteins. (Y-N. Chen, et al., “Antiviral Activity of Graphene-Silver Nanocomposites against Non-Enveloped and Enveloped Viruses,” Int. J. Environ. Res. Public Health, 2016, 13, 430). In another study, a 90% reduction in viral titers were observed within 4 hours of exposure to silver for HIV, influenza, herpes simplex and dengue viruses. (J. Hodek, et al., “Protective hybrid coating containing silver, copper and zinc cations effective against human immunodeficiency virus and other enveloped viruses,” BMC Microbiol. 2016 Apr. 1; 16)

Conventional face masks are considered an important measure to lessen the spread of SARS-CoV-2. However, studies have shown that a possible side effect of their use is that they can cause or worsen dermatological problems. One such cause has been attributed to the transfer of bacteria from sweat and body oils to the interior of the face mask where it can grow and lead to subsequent breakouts and other skin irritations. In a related study, the prevalence of face mask-related adverse skin reactions found that acne was the most frequent (54.5%), followed by facial rashes (39.9%) and then symptoms of itching (18.4%). Not surprisingly, it was also found that the risk of adverse skin reactions increased through reuse and wearing of the face mask for more than 4 hours/day.

In particular, surgical masks have also been shown to have a higher risk of adverse skin reaction compared to cloth masks. The two primary types of face masks used in the healthcare setting are surgical/procedure (medical) masks and N95 respirators. Allergic Contact Dermatitis (ACD) is a delayed type IV hypersensitivity reaction that can develop in response to allergens in the environment. In one study, it was reported that healthcare workers were at a greater risk of mask-associated ACD from prolonged wear (>6 hours/day) and exposure to PPE. Sources of possible allergens from exposure to PPE have been attributed to (i) the elastic straps, (ii) adhesive chemicals used in the construction of medical face masks and N95 respirators, and (iii) formaldehyde, which is used as a preservative in the production of paper products. (J. Yu, et al., “Occupational dermatitis to facial personal protective equipment in health care workers: A systematic review,” J Am Acad Dermatol. 2021 February; 84 (2): 486-494)

Thus, according to another aspect of the present invention, the face mask further comprises an interior silver fabric layer 18 which has antiviral properties to reduce the negative health effects of the SARS-CoV-2 virus and kill bacteria on contact that may cause skin problems. There are numerous commercially-available silver fabrics that may be employed for use in a face mask. According to one embodiment of the present invention, the silver fabric used as the interior layer of the face mask is made by a patented polymer process which delivers silver ions through an intelligent control mechanism (SILVADUR™). Furthermore, the silver fabric layer is preferably made from a natural fiber which is comfortable when worn next to the skin, such as cotton or a cotton blend.

The interior silver fabric layer 18 serves two important purposes with respect to its use in the face mask. Firstly, cotton is a natural fiber and when woven into fabric, is very breathable, soft to the touch, durable, hypoallergenic, and odor-free. Since cotton is also very water absorbent and dries quickly, it has excellent moisture-wicking abilities which provides a cool, dry and fresh feel when worn next to the skin. In light of these desirable properties, cotton is the most widely used textile which is manufactured in a variety of products such as clothing, bath linens, bedding and medical supplies.

Secondly, due to the antimicrobial properties of the silver-treated fabric, the silver ions can interact with microorganisms on contact to prevent viral and/or bacterial infection. The silver fabric employed in the face mask is able to kill 99.9% of bacteria and therefore, helps to prevent breakouts and skin-related problems that are irritating and unsightly. It is also capable of wicking sweat away from the body surface to keep the skin of the wearer comfortable and dry. The fabric used in the interior layer of the face mask has also be proven to be safe when worn against the skin and that no skin irritation or sensitization has been found after multiple exposures.

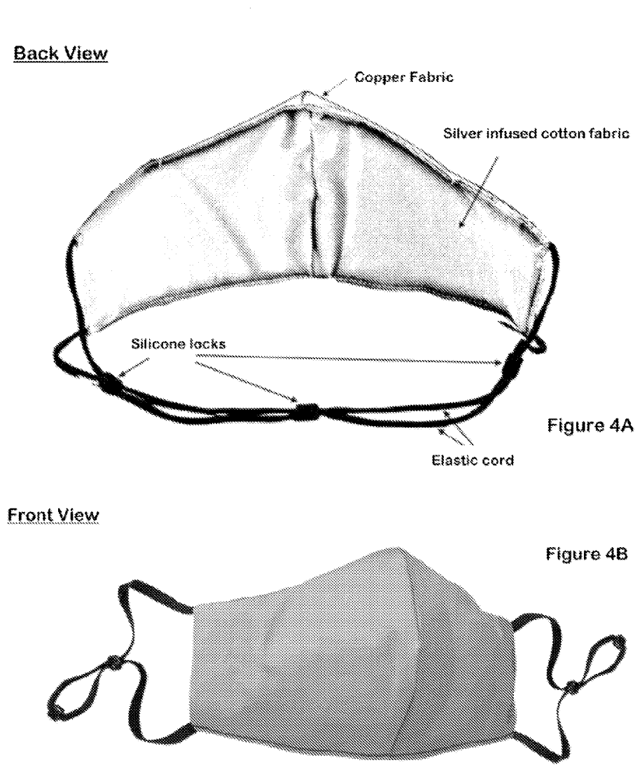

FIGS. 2 to 4 illustrate an example of the face mask, and possible positions for its use. The face mask in some examples has two ear loops and a behind the head extension loop as best shown in FIG. 4. Silicone locks as pictured in the drawings allow various use positions over the ears and/or behind the head.

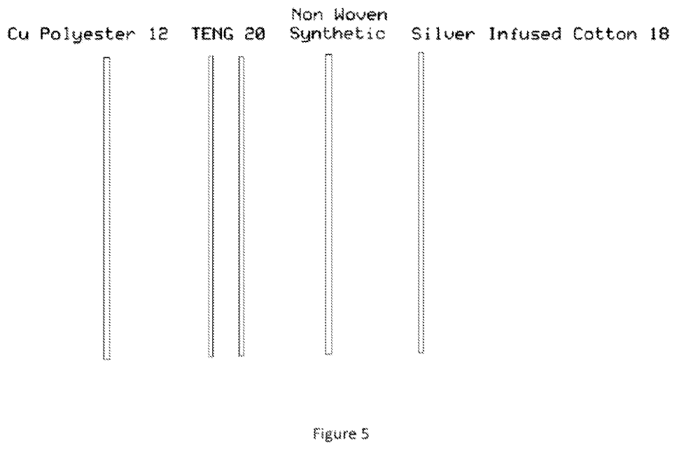

According to another aspect of the present invention, and as illustrated in FIG. 5, the face mask may additionally comprise a breathable non-woven layer made from synthetic material which is located between the interior silver fabric layer 18 and the TENG membrane 20. Preferably, the non-woven synthetic layer is made from a thermoplastic polymer such as polypropylene (PP), polystyrene, polycarbonate, polyaramid, polyethylene or polyester. Due to the hydrophobic properties of the synthetic layer, it serves to prevent wicking transport of droplets from the adjacent absorbent cotton layer through to the other layers of the face mask. Preferably, the additional layer comprises a non-woven PP fabric. More preferably, the additional layer comprises a melt-blown non-woven PP fabric. In addition to its hydrophobic properties, the melt-blown non-woven PP fabric can remove bacteria, viruses and aerosols containing microorganisms by physical filtration and electrostatic absorption when air is permeated through.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A face mask comprising:
an interior antimicrobial layer and an exterior antimicrobial layer; and
a triboelectric nanogenerator (TENG) membrane located between the interior and exterior antimicrobial layers, wherein the TENG membrane comprises two different flexible layers having distinct triboelectric polarities.

2. The face mask of claim 1, wherein at least one layer of the TENG membrane comprises a porous mesh fabric.

3. The face mask of claim 1, wherein the exterior antimicrobial layer comprises copper.

4. The face mask of claim 3, wherein the exterior antimicrobial layer comprises a sputtered copper polyester fabric.

5. The face mask of claim 1, wherein the interior antimicrobial layer comprises silver.

6. The face mask of claim 5, wherein the interior antimicrobial layer comprises a silver-infused cotton fabric.

7. The face mask of claim 1, wherein the TENG membrane comprises a nylon fabric and a fabric selected from the group consisting of polyester, polytetrafluoroethylene, polydimethylsiloxane, polyvinyl chloride, polyimide, polypropylene, polyethylene and polyvinylidene fluoride.

8. The face mask of claim 1, wherein the TENG membrane comprises a nylon fabric and at least one of a polyester fabric or a polytetrafluoroethylene fabric.

9. The face mask of claim 1, further comprising at least one of two ear loops and a behind-the-head extension loop.

10. The face mask of claim 1, further comprising an embedded wire stiffener to secure the face mask at the nose when worn.

11. The face mask of claim 1, wherein the TENG membrane comprises two different porous mesh fabrics that have distinct triboelectric polarities.

12. The face mask of claim 11, wherein the two different porous mesh fabrics of the TENG membrane are adjacent to one another.

13. The face mask of claim 11, wherein the two different porous mesh fabrics of the TENG membrane are adjacent to one another and close enough such that they are configured to touch when the wearer breathes.

14. The face mask of claim 1, further comprising a breathable non-woven layer made from synthetic material and located between the interior layer and the TENG membrane.

15. The face mask of claim 14, wherein the breathable non-woven layer is made from a thermoplastic polymer.

16. A face mask comprising:
an interior antimicrobial layer of silver-infused cotton fabric;
an exterior antimicrobial layer of sputtered copper polyester fabric; and
a triboelectric nanogenerator (TENG) membrane located between the interior and exterior antimicrobial layers, wherein the TENG membrane comprises separate nylon-based and polyester-based or polytetrafluoroethylene-based porous mesh fabrics.

17. The face mask of claim 16, further comprising at least one of two ear loops and a behind-the-head extension loop, and an embedded wire stiffener to secure the face mask at the nose when worn.

18. The face mask of claim 16, wherein the two separate porous mesh fabrics of the TENG membrane are adjacent to one another.

19. The face mask of claim 16, wherein the two separate porous mesh fabrics of the TENG membrane are adjacent to one another and close enough such that they are configured to touch when the wearer breathes.

20. The face mask of claim 16, further comprising a breathable non-woven layer made from synthetic material and located between the interior layer and the TENG membrane.
